(19) United States
(12) Patent Application Publication
(10) Pub. No.: US 2008/0304275 A1
(43) Pub. Date: Dec. 11, 2008

(54) Lamp With Light Absorbing Coating

(76) Inventors: Mederic Le Parc, Chartres (FR); Remy Cyrille Broersma, Mainvilliers (FR); Jean-Francois Rame, Montreuil (FR); Jean-Sebastien Straetmans, Chartres (FR)

Correspondence Address: Philips Electronics North Americia Corporation;Corporate Patent Counsel, P. O. Box 3001, Briarcliff Manor, NY, 10510, US

(21) Appl. No.: 10/578,066

(22) PCT Filed: Oct. 20, 2004
(86) PCT No.: PCT/IB04/03501

§ 371 Date: May 2, 2006

(30) Foreign Application Priority Data
Nov. 6, 2003 (EP) 03300198.3

(51) Int. Cl. B60Q 1/00; H01J 61/02; H01J 61/35; H01J 61/40

(52) U.S. Cl. 362/488; 313/113

(57) ABSTRACT

The invention relates to a tubular lamp comprising a lamp vessel (10) which accommodates a light source (11a, 11b, 11c). A first part of the lamp vessel is provided with a coating (13) reflective of radiation emitted by said light source. A second part of the lamp vessel is provided with a light-absorbing coating (14). The light absorbing coating comprises pigments incorporated in a sol gel matrix.

### FIELD OF THE INVENTION

The present invention relates to a tubular lamp comprising a lamp vessel which accommodates a light source, wherein a first part of the lamp vessel is provided with a coating reflective of radiation emitted by said light source.

The present invention also relates to a tubular lamp vessel having a first part provided with a reflective coating, as well as a luminaire comprising a tubular lamp.

The present invention is particularly relevant for automotive lamps, such as lamps used for interior lighting of a car.

### BACKGROUND OF THE INVENTION

A tubular lamp comprising a lamp vessel which accommodates a light source, wherein a first part of the lamp vessel is provided with a coating reflective of radiation emitted by said light source is known from U.S. Pat. No. 4,710,677. In such a lamp, a coating of a suitable reflective material is applied to a part of the surface of the lamp vessel, in order to maximise the amount of radiation available for use. This avoids loss of light when the lamp is used in only one direction. For example, when the lamp is placed in the roof of a car, only the light emitted towards the interior of the car is useful. Without any reflector, the light emitted towards the roof is thus lost. Moreover, the use of a reflective coating avoids use of an external reflector, which is bulky and requires a complicated assembly process.

However, when such a lamp is used for emitting visible light, the colour of the emitted light depends on the light source. Conventional light sources such as a coiled wire emit visible light in the white zone of the CIE 1931 chromaticity diagram. Now, other colours might be desired, such as a blue light for providing a stimulating light in the interior of the car and preventing the driver from falling asleep.

### SUMMARY OF THE INVENTION

It is an object of the invention to provide a tubular lamp which avoids loss of light and emits light with a colour different from the colour of light emitted by the light source.

To this end, the invention proposes a tubular lamp comprising a lamp vessel which accommodates a light source, wherein a first part of the lamp vessel is provided with a coating reflective of radiation emitted by said light source, a second part of the lamp vessel being further provided with a light-absorbing coating comprising pigments incorporated in a sol gel matrix.

In addition to the reflective coating which aims at avoiding loss of light, the lamp in accordance with the invention comprises, on a part of the lamp vessel, a light absorbing coating comprising pigments. This light absorbing coating absorbs certain wavelengths of the light emitted by the light source, so that the colour of said light is modified when passing through said light absorbing coating. By suitably choosing the pigments, the desired colour can be obtained.

Moreover, the applicant has noticed that, in a tubular lamp comprising a lamp vessel having a part provided with a reflective coating, the parts of the lamp vessel that are not coated with said reflective coating reach a relatively high temperature. For example, in a festoon type lamp without reflective coating, the lamp vessel reaches about 200 degrees Celsius, whereas in the same lamp with a reflective coating, the parts of the lamp vessel that are not coated with said reflective coating reach more than 300 degrees. A light-absorbing coating comprising pigments incorporated in a sol gel matrix resists to such a temperature. Hence, the lamp in accordance with the invention is not degraded during use of the lamp.

Advantageously, the first part is distinct from the second part. This means that the light absorbing coating is not present where the reflective coating is present. This avoids employing more light absorbing coating than necessary. Moreover, if the first part is not distinct from the second part and if the reflective coating and the light absorbing coating are on the external surface of the lamp vessel, a part of the reflective coating is deposited on a part of the light absorbing coating, or vice versa. Now, the deposition of the reflective coating on the light absorbing coating might alter the light absorbing coating, and vice versa. Having the first part distinct from the second part alleviates this drawback.

Preferably, the first part represents substantially half of the lamp vessel and the second part represents substantially half of the lamp vessel. Such a lamp provides a coloured rectangular ray of light, which is well adapted for car applications, such as map reading or ID numbers enlightening.

Advantageously, the lamp further comprises at least one end cap, said end cap comprising orientation means for cooperating with a lamp housing intended to receive said lamp. Such orientation means allow right positioning of the lamp in its housing. For example, if the lamp housing is in the roof of a car, the orientation means are designed in such a way that the lamp can only be placed in a given position in the lamp housing, in which position the part of the lamp vessel coated with the reflective coating faces said roof.

The invention also relates to a tubular lamp vessel having a first part provided with a reflective coating and a second part provided with a light-absorbing coating comprising pigments incorporated in a sol gel matrix.

The invention also relates to a luminaire comprising a tubular lamp as described above.

These and other aspects of the invention will be apparent from and elucidated with reference to the embodiments described hereinafter.

### BRIEF DESCRIPTION OF THE DRAWINGS

The invention will now be described in more detail, by way of example, with reference to the accompanying drawings, in which:

FIG. 1a shows a lamp in accordance with the invention and FIG. 1b is a cross section of the lamp of FIG. 1a;

FIG. 2a shows a lamp in accordance with an advantageous embodiment of the invention and FIG. 2b is a cross section of the lamp of FIG. 2a.

### DETAILED DESCRIPTION OF THE INVENTION

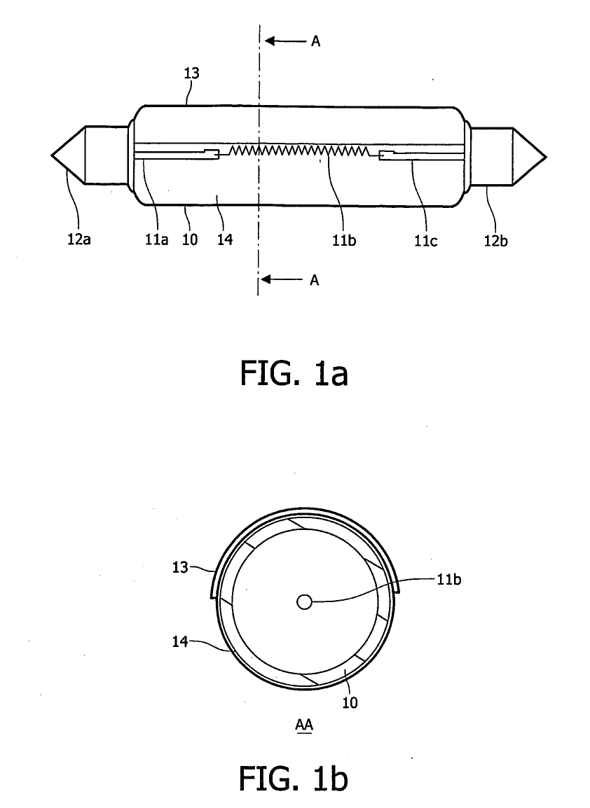

A lamp in accordance with the invention is depicted in FIGS. 1a and 1b. FIG. 1b is a cross section in the plane AA of FIG. 1a. Such a lamp is of the festoon type, although the invention applies to other types of lamp. The lamp comprises a lamp vessel 10, a light source comprising a first straight section of nickel plated dumet 11a, a coiled wire 11b and a second straight section of nickel plated dumet 11c, a first end cap 12a, a second end cap 12b, a reflective coating 13 and a light absorbing coating 14. In FIG. 1a, the light absorbing coating 14 is represented transparent, but it might be translucent such that the light source is not visible when the lamp is viewed from the exterior.

It should be noted that the thickness of the reflective coating 13 and the light absorbing coating 14 is emphasized in FIG. 1b, for reasons of convenience. For example, the lamp vessel 10 has a thickness of 1 millimetre and the reflective coating 13 and the light absorbing coating 14 have a thickness of a few micrometers.

The lamp vessel 10 is filled with an inert gas, such as helium, neon, argon, krypton, radon or xenon. The inert gas reduces tungsten evaporation and thus allows higher operation temperature of the light source. When the lamp is operating, an electrical current is provided between the first and second end caps 12a and 12b, which electrical current heats the light source, so that visible light is produced.

As can be seen from FIG. 1b, the reflective coating 13 is deposited on a first part of the lamp vessel 10. The first part of the lamp vessel 10 preferably represents half of the lamp vessel 10, but might represent less or more than half of the lamp vessel 10. However, the first part of the lamp vessel 10 should not represent the whole lamp vessel, because in this case no light would exit the lamp. The light absorbing coating 14 is deposited on a second part of the lamp vessel 10. The second part of the lamp vessel 10 might represent the whole lamp vessel 10, as is the case in FIG. 1b.

In the example of FIG. 1b, the light absorbing coating 14 is first deposited on an external surface of the lamp vessel 10 and then the reflective coating 13 is deposited on a part of the light absorbing coating 14. However, the light absorbing coating 14 and/or the reflective coating 13 might be deposited on an internal surface of the lamp vessel 10. Moreover, the light absorbing coating 14 might be deposited on the reflective coating 13.

The reflective coating 13 is of any type that allows for reflecting the visible light emitted by the light source. For example, a silver or aluminium coating might be used, which can be deposited on the lamp vessel 10 or on the light absorbing coating 14 by means of vapour deposition. When light emitted by the light source reaches the reflective coating 13, it is reflected towards a direction opposed to the reflective coating 13 compared to the light source. If the lamp is positioned in such a way that this direction is the direction where objects have to be enlightened, then the reflective coating 13 avoids loss of light. Moreover, the light emitted in this direction passes through the light absorbing coating 14, which absorbs certain wavelengths of said light, thus modifying the colour of the light that exits the lamp.

The light absorbing coating 14 comprises pigments incorporated in a sol gel matrix. Preferably, the pigments are inorganic pigments, which have good temperature stability. The pigments can be selected from the group formed by iron oxide, iron oxide doped with phosphor, zinc-iron oxide, cobalt aluminate, neodymium oxide, bismuth vanadate, zirconium praseodymium silicate or mixtures thereof. Iron oxide (Fe2O3) is an orange pigment and P-doped Fe203 is an orange-red pigment. Zinc-iron oxide, for example ZnFe2O4 or ZnO.ZnFe2O4 are yellow pigments. Mixing (P-doped) Fe203 with ZnFe204 yields a pigment of a deep orange colour. Cobalt aluminate (CoAl204) and neodymium oxide (Nd205) are blue pigments. Bismuth vanadate (BiVO4), also referred to as pucherite, is a yellow-green pigment. Zirconium praseodymium silicate is a yellow pigment.

In an alternative embodiment, organic pigments are used. Particularly suitable pigments are the so-called Red 177 (anthraquinone) or chromium phthalic yellow (2RLP) from “Ciba”. Further suitable pigments are Red 149 (perylene), Red 122 (quinacridone), Red 257 (Ni-isoindoline), Violet 19 (quinacridone), Blue 15:1 (Cu-phthalocyanine), Green 7 (hal.Cu-phthalocyanine) or Yellow 83 (dyaryl) from “Clariant”. Also mixtures of inorganic and organic pigments are suitable, for example a mixture of chromium phthalic yellow and (zinc)iron oxide.

The sol gel matrix can for example be obtained by conversion of an organically modified silane by means of a sol-gel process, said organically modified silane being selected from the group formed by compounds of the following structural formula: RISi(ORII)3, wherein RI comprises an alkyl group or an aryl-group, and RII comprises an alkyl group. For example, RI comprises CH3 or C6H5. These substances have a relatively good thermal stability. A matrix comprising methyl or phenyl groups enables thick light absorbing coatings to be obtained. Methyltrimethoxysilane (MTMS) is an example of a suitable starting material for the sol-gel matrix. Experiments have shown that light absorbing coatings wherein methyl or phenyl groups are incorporated in a sol-gel matrix are stable up to a temperature of at least 350° C.

A thick light absorbing coating is preferred, such as a light absorbing coating having a thickness superior to 1 micrometer. Actually, such a coating can incorporate more pigments, thereby improving the colour effect of the coating.

Moreover, a good thermal stability is particularly advantageous in a lamp in accordance with the invention. Actually, the applicant has noticed that in a tubular lamp provided with a reflective coating, the part of the lamp vessel which is not coated with the reflective coating reaches a temperature that is higher that the temperature of a lamp vessel which is not provided with a reflective coating. This is due to the fact that the lamp is tubular and that a reflective coating is deposited on a part of the lamp vessel. Due to the geometry of the tubular lamp, a relatively high quantity of light passes through the part of the lamp vessel which is not coated with the reflective coating. However, the applicant has noticed that the light absorbing coating 14 comprising pigments incorporated in a sol-gel matrix is not degraded during operation of the lamp in accordance with the invention.

The pigments can be stabilized in the sol-gel matrix by means of an organic polymer, as explained in the patent application WO 01/20641 in the name of the current applicant. Alternatively, aminosilane can be used as a stabilizer for the pigments in the sol-gel matrix, as explained in the patent application WO 03/023816 also in the name of the current applicant.

The sol gel process is well known from those skilled in the art. Patent applications WO 01/20641 and WO 03/023816 describe examples of manufacturing a light absorbing coating comprising pigments incorporated in a sol gel matrix. A further example is given below, for preparation of a light absorbing coating suitable for a lamp emitting substantially blue light.

Neodymium oxide (Nd205) is stabilized in a 50/50% water/ethanol mixture using dimethylaminopropylsilane as a stabilizer. To this end, a dispersion of Neodymium oxide is made using 5 g Nd205 to which 20 g of a slightly acidified 50/50% water/ethanol mixture is added. Subsequently 0.1 g dimethylamino-propylsilane is added and the dispersion is milled using 2 mm zirconia milling balls. Separately, a sol-gel hydrolysis mixture is made. A tetraethoxysilane(TEOS) hydrolysis mixture is made by mixing 15 g TEOS, 50 g ethanol, 3.6 g water and 1.1 g of 0.2M HCl and subjecting said mixture to hydrolysis during 36 hours. A light absorbing coating liquid is prepared by mixing the Nd205 dispersion and the hydrolysis mixture in a ratio of 1:1 and adding 20 wt. % methoxypropanol to the mixture. The light absorbing coating is subsequently spray coated onto the external surface of the lamp vessel. The light absorbing coating is cured for 10 minutes at a temperature of 250° C. In this manner, a light-absorbing coating in a thickness of 1.5 micrometers is obtained on a glass lamp vessel without crack formation during drying and curing.

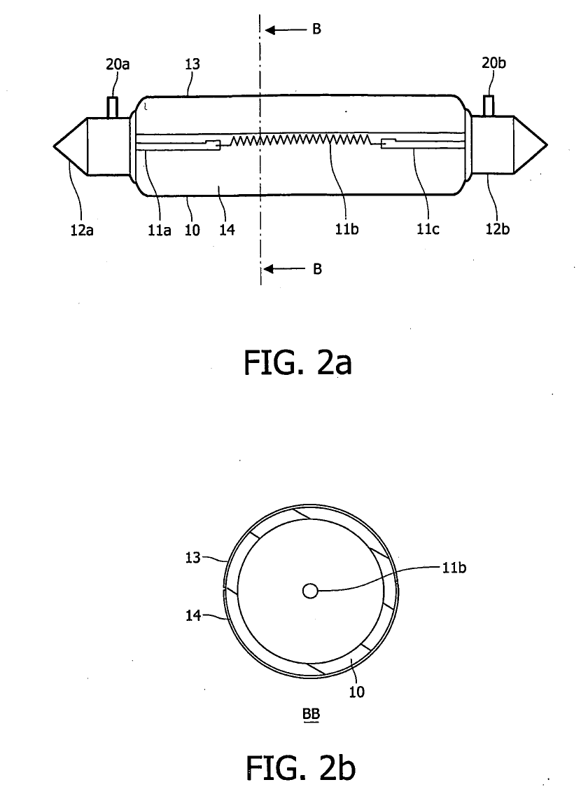

A lamp in accordance with an advantageous embodiment of the invention is depicted in FIGS. 2a and 2b. FIG. 2b is a cross section in the plane BB of FIG. 2a. In addition to elements described in FIGS. 1a and 1b with the same reference numbers, the lamp of FIGS. 2a and 2b comprises a first orientation pin 20a and a second orientation pin 20b. The first and second orientation pins 20a and 20b are orientation means, which allows orientating the lamp in respect with a lamp housing. The orientation means are intended to cooperate with cooperating means of the lamp housing in such a way that the first and second orientation pins 20a and 20b are placed in a predetermined position in respect with the lamp housing. As the position of the reflective coating 13 in respect with the first and second orientation pins 20a and 20b is also predetermined, the position of the reflective coating 13 in respect with the lamp housing is predetermined. This allows a simple positioning of the lamp in its lamp housing, without taking care of the position of the reflective coating while positioning said lamp. Moreover, the orientation pins 20a and 20b avoid the lamp to rotate in the lamp housing in case of shock for example. Hence, the position of the reflective coating 13 remains the same in the lamp housing, which ensures that the lamp is used in an effective way throughout its life.

It should be noticed that the orientation means might comprise only one orientation pin.

Moreover, in the lamp of FIGS. 2a and 2b, the second part of the lamp vessel 10, which is provided with the light absorbing coating 14, is distinct from the first part of said lamp vessel 10, which is provided with the reflective coating 13. The first and the second part of the lamp vessel 10 each represents substantially half of the lamp vessel 10. In this case, a wide rectangular ray of coloured light is obtained, while reducing the loss of light emitted by the radiation source.

If a smaller rectangular ray of light is desired, then the first part represents more than half the lamp vessel 10. Although the part of the lamp vessel 10 which is not coated with the reflective coating 13 in this case reaches higher temperatures, this part might be provided with a light absorbing coating comprising pigments incorporated in a sol gel matrix, because said light absorbing coating resist to such temperatures.

A luminaire might be manufactured with a lamp as described in FIG. 1a or 2a. Such a luminaire comprises a tubular lamp and a lamp housing adapted for receiving said tubular lamp.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. A tubular lamp comprising a lamp vessel (10) which accommodates a light source (11a, 11b, 11c), wherein a first part of the lamp vessel is provided with a coating (13) reflective of radiation emitted by said light source, a second part of the lamp vessel being further provided with a light-absorbing coating (14) comprising pigments incorporated in a sol gel matrix.

2. A tubular lamp as claimed in claim 1, wherein the first part is distinct from the second part.

3. A tubular lamp as claimed in claim 2, wherein the first part represents substantially half of the lamp vessel and the second part represents substantially half of the lamp vessel.

4. A tubular lamp as claimed in claim 1, further comprising at least one end cap (12a), said end cap comprising orientation means (20a) for cooperating with a lamp housing intended to receive said lamp.

5. A tubular lamp as claimed in claim 4, wherein said orientation means comprise at least one orientation pin (20a).

6. A tubular lamp vessel having a first part provided with a reflective coating and a second part provided with a light-absorbing coating comprising pigments incorporated in a sol gel matrix.

7. A luminaire comprising a tubular lamp as claimed in claim 1.
